(19) United States
(12) Patent Application Publication
(10) Pub. No.: US 2022/0138154 A1
(43) Pub. Date: May 5, 2022

(54) STORAGE DEVICES FOR STORING LOG FILES

(71) Applicant: Hewlett-Packard Development Company, L.P., Spring, TX (US)

(72) Inventors: Xinwei Zhang, Fort Collins, CO (US); Daniel Bungert, Fort Collins, CO (US)

(73) Assignee: Hewlett-Packard Development Company, L.P., Spring, TX (US)

(21) Appl. No.: 17/419,031

(22) PCT Filed: Jul. 24, 2019
(86) PCT No.: PCT/US2019/043270

§ 371 Date: Jun. 28, 2021

(51) Int. Cl. G06F 16/13; G06F 16/16; G06F 11/36

(52) U.S. Cl. CPC G06F 16/13; G06F 11/366; G06F 16/162

(57) ABSTRACT

In an example implementation according to aspects of the present disclosure, a method may include, upon generating a log file, determining whether a primary log storage device is accessible, and if the primary log storage device is inaccessible, identifying storage devices available for storing the log file. For each storage device identified, the method includes determining factors, and choosing a storage device from the identified storage devices based on the determined factors. The method includes storing the log file on the chosen storage device.

### BACKGROUND

Computer program may generate logs to aid in the debugging or troubleshooting of the operation of the program. Log files are a standard tool for developers and administrators, by recording the “what happened when by whom” of the system. As an example, the information from log files can record faults and help with their diagnosis. The information generated and stored, for example, on a storage device, may be available for later analysis if it is stored in a form that can be analyzed. As an example, plain text format minimizes dependencies on other system processes, and assists logging at all phases of computer operation, including start-up and shut-down, where such processes might be unavailable. There are times that the storage device for storing log files, known as a primary log storage device, may not be available. When that happens, log files and/or diagnostic information may not be recorded, severely limiting the debugging or troubleshooting of the operation of a program.

### BRIEF DESCRIPTION OF THE DRAWINGS

FIG. 1 illustrates a computing device for identifying storage devices available for storing log files, according to an example;

FIG. 2 illustrates a method for identifying storage devices available for storing log files, according to an example; and

FIG. 3 is a flow diagram in accordance with an example of the present disclosure.

### DETAILED DESCRIPTION

Examples disclosed herein provide the ability to search a computing device and/or network to look for places that a program can store its log and diagnostic information in cases where the primary log storage device has either failed or is inaccessible. As will be further described, an automatic discovery may be initiated to find where the program can store its log and diagnostic information. In addition, as part of the troubleshooting process, a similar discovery process may be initiated to find where the log and diagnostic information was stored. As a result, when the primary log storage device is unavailable, logs may still be stored and made accessible, in order to field issues.

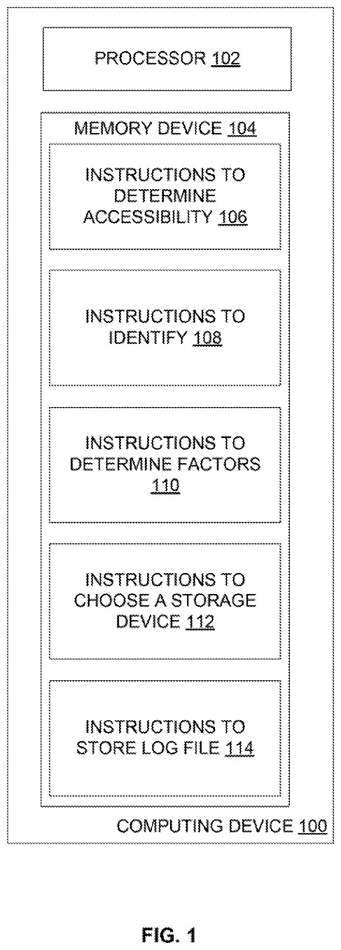

With reference to the figures, FIG. 1 illustrates a computing device 100 for identifying storage devices available for storing log files, according to an example. The computing device 100 depicts a processor 102 and a memory device 104 and, as an example of the computing device 100 performing its operations, the memory device 104 may include instructions 106-114 that are executable by the processor 102. Thus, memory device 104 can be said to store program instructions that, when executed by processor 102, implement the components of the computing device 100. The executable program instructions stored in the memory device 104 include, as an example, instructions to determine accessibility (106), instructions to identify (108), instructions to determine factors (110), instructions to choose a storage device (112), and instructions to store log file (114).

Instructions to determine accessibility (106) represent program instructions that when executed by the processor 102 cause the computing device 100, upon generating a log file, to determine whether a primary log storage device is accessible. As an example, the primary log storage device may be either on a local file system of the computing device 100 or a remote system networked with the computing device 100. However, the primary log storage device may become inaccessible, for example, if it has experienced a failure or the network becomes inaccessible, making the primary log storage device no longer available.

Instructions to identify (108) represent program instructions that when executed by the processor 102 cause the computing device 100, if the primary storage device is inaccessible, to identify storage devices available for storing the log file. As an example, the list of destinations that can be identified for storing log files includes, but are not limited to, additional hard disk drives (HDDs) installed in or coupled to the computing device 100, a portable storage device like a USB flash drive, on-board devices like a basic input/output system (BIOS) or Trusted Platform Module (TPM), a network-accessible location that may be well known, and network locations found in Dynamic Host Configuration Protocol (DHCP) tags.

Instructions to determine factors (110) represent program instructions that when executed by the processor 102 cause the computing device 100 to determine factors for each storage device identified. As an example of a factor, the remaining storage space available for each identified storage device may be determined. In addition to determining the remaining capacity of each identified storage device, the ease of using each storage device, along with its safety and volatility, may be determined as well.

Instructions to choose a storage device (112) represent program instructions that when executed by the processor 102 cause the computing device 100 to choose a storage device from the identified storage devices based on the determined factors. As described above, the factors determined for each storage device may vary. In addition, although multiple factors may be determined for each storage device, the factors used for choosing a storage device from the identified storage devices may vary as well. For example, a single factor may be relied upon for choosing the storage device or a combination of factors may be utilized. The weight given for each factor may vary as well when a combination of factors is utilized for choosing the storage device from the identified storage devices. For example, the computing device 100 may rely on a weighted average of the factors when choosing the storage device from the identified storage devices.

As an example, the storage device that is chosen may be based on the remaining storage space available. To allow for sufficient storage space for storing the log file, the storage device with the greatest remaining storage space available may be chosen.

Instructions to store log file (114) represent program instructions that when executed by the processor 102 cause the computing device 100 to store the log file on the chosen storage device. Although a storage device may be chosen, for example, based on the storage space available, at times, the available storage space may not be sufficient for storing the log file. As the diagnostic data set found in generated log files may be fairly large, this may be an issue, for example, when certain storage devices, such as TPM, are chosen, which may not be able to accommodate the large log file. However, as will be further described, crucial information from the log file that its on the chosen storage device may be selected for storage.

As an example, further program instructions, which when executed by the processor 102, may cause the computing device 100 to determine whether a size of the log file is greater than the remaining storage space available on the chosen storage device, if the size of log file is greater than the remaining storage space available on the chosen storage device, the computing device may choose a scaled-down version of the log file to fit on the remaining storage space available on the chosen storage device. Generation of the scaled-down version of the log file may vary. For example, the diagnostic script that generates the log file may generate several different sets of log files, for example, in increasing verbosity, which the computing device 100 may then select from, based on the storage space available on the chosen storage device. As an example, rather than generating several different sets of log files, the diagnostic script may add a filter script in the generated log file, which the computing device may then call upon (e.g., once or multiple times) to “shrink” the diagnostic data set found in generated log file down to a level that can fit on the chosen storage device.

Upon storing the log file on the chosen storage device, further program instructions, which when executed by the processor 102, may cause the computing device 100 to tag the log file for later identification, for example, to be harvested at a later time as part of the troubleshooting process. As an example, rather than tagging the log file, the storage device chosen for storing the log file may be tagged instead. In addition, rather than tagging either the log file or storage device, debug logs may be stored in special file formats and unique filenames that may be identifiable, for example, during a recovery mode. However, that may not always be possible, as different storage devices have different capabilities. For example, as some storage devices may not support a full featured file system, the log file, or the storage device containing the log file, may need to be tagged instead.

As part of the troubleshooting process, the computing device 100 may utilize a recovery program to later search identified storage devices for the tagged log file (or tagged storage device) and, upon collecting information from the tagged log file, the computing device 100 may delete it from the storage device. As an example, a log collection script may be run by a technician or customer on the computing device 100 in order to locate the tagged log file or storage device. The collection script may include instructions similar to those described above, such as identifying storage devices available for storing log files (e.g., instruction 108). Upon identifying the available storage devices, the computing device 100 may then search the storage devices for the tagged log file. If the storage device is tagged instead, the computing device 100 may search for the tagged storage device and, as an example, locate a log file that may have a unique filename or have a special file format.

Memory device 104 represents generally any number of memory components capable of storing instructions that can be executed by processor 102. Memory device 104 is non-transitory in the sense that it does not encompass a transitory signal but instead is made up of at least one memory component configured to store the relevant instructions. As a result, the memory device 104 may be a non transitory computer-readable storage medium. Memory device 104 may be implemented in a single device or distributed across devices. Likewise, processor 102 represents any number of processors capable of executing instructions stored by memory device 104. Processor 102 may be integrated in a single device or distributed across devices. Further, memory device 104 may be fully or partially integrated in the same device as processor 102, or it may be separate but accessible to that device and processor 102.

In one example, the program instructions 106-114 can be part of an installation package that when installed can be executed by processor 102 to implement the components of the computing device 100. In this case, memory device 104 may be a portable medium such as a CD, DVD, or flash drive or a memory maintained by a server from which the installation package can be downloaded and installed. in another example, the program instructions may be part of an application or applications already installed. Here, memory device 104 can include integrated memory such as a hard drive solid state drive, or the like.

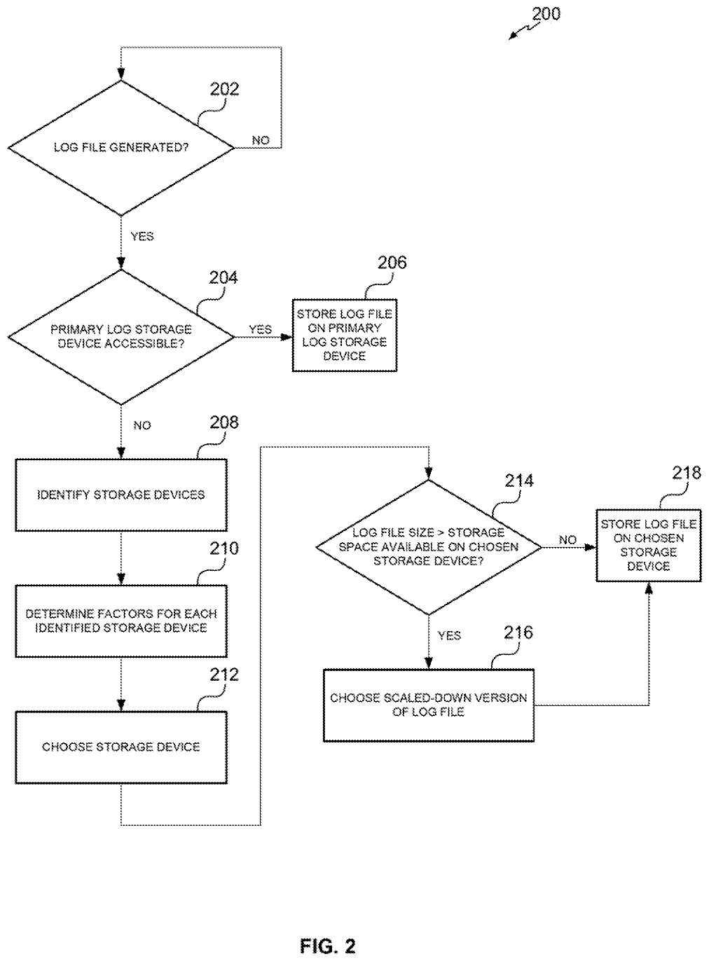

FIG. 2 illustrates a method 200, for example, at a computing device, for identifying storage devices available for storing log files, according to an example. In discussing FIG. 2, reference may be made to the example computing device 100 illustrated in FIG. 1. Such reference is made to provide contextual examples and not to limit the manner in which method 200 depicted by FIG. 2 may be implemented.

Method 200 begins at 202, where the computing device determines whether a log file has been generated. As described above, a log file may be generated, for example, when a program or application installed on the computing device encounters an error. At 204, the computing device determines whether the primary log storage device, for example, where log files are generally stored, is accessible. As an example, the primary log storage device may become inaccessible, for example, if it has experienced a failure or the network becomes inaccessible, making a remote primary log storage device no longer available. At 206, if the primary log storage device is accessible, the computing device stores the log file on the primary log storage device, and method 200 ends.

However, at 208, if the primary log storage device is inaccessible, the computing device identifies storage devices available for storing the log file. As mentioned above, the list of destinations that can be identified for storing log files includes, but are not limited to, additional hard disk drives (HDDs) installed in or coupled to the computing device, a portable storage device like a USB flash drive, on-board devices like a basic input/output system (BIOS) or Trusted Platform Module (TPM), a network accessible location that may be well known, and network locations found in Dynamic Host Configuration Protocol (DHCP) tags.

At 210, the computing device determines factors for each storage device identified. Although various factors can be determined, as described above, a key factor may be the remaining storage space available for each identified storage device. At 212, based on the determined factors, the computing device may choose a storage device from the identified storage devices. As an example, by relying on the remaining storage space available for each identified storage device, the computing device may choose the storage device with the greatest remaining storage space available, to allow for sufficient storage space for storing the log file. However, other factors may be relied upon when choosing the storage device, as described above.

At 214, upon choosing the storage device, the computing device determines whether the size of the log file is greater than the storage space available on the chosen storage device. At 218, if the size of the log file is less than the storage space available on the chosen storage device, the computing device stores the log file on the chosen storage device. However, at 216, if the size of the log file is greater than the available storage space, the computing device chooses a scaled-down version of the log file, as described above. Upon choosing the scaled-down version that fits on the chosen storage device, the computing device may then store the scaled-down version of the log file on the chosen storage device, at 218.

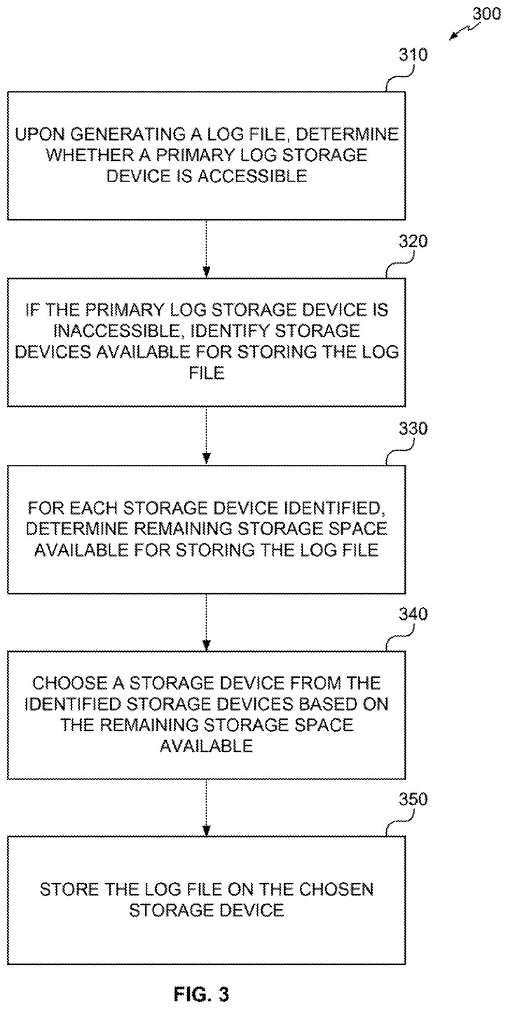

FIG. 3 is a flow diagram 300 of steps taken by a computing device to identify storage devices available for storing log files, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 310, upon generating a log file, the computing device determines whether a primary log storage device is accessible. As an example, the primary log storage device may become inaccessible, for example, if it has experienced a failure or the network becomes inaccessible, making a remote primary log storage device no longer available. At 320, if the primary log storage device is inaccessible, the computing device identifies storage devices available for storing the log file, as described above.

At 330, for each storage device identified, the computing device determines remaining storage space available for storing the log file. At 340, the computing device chooses a storage device from the identified storage devices based on the remaining storage space available. As an example, by relying on the remaining storage space available for each identified storage device, the computing device may choose the storage device with the greatest remaining storage space available, to allow for sufficient storage space for storing the log file. However, other factors may be relied upon when choosing the storage device, as described above. At 350, the computing device stores the log file on the chosen storage device.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed s:

1. A method comprising:
upon generating a log file, determining whether a primary log storage device is accessible;
if the primary log storage device is inaccessible, identifying storage devices available for storing the Jog file;
for each storage device identified, determining remaining storage space available for storing the log file;
choosing a storage device from the identified storage devices based on the remaining storage space available; and
storing the log file on the chosen storage device.

2. The method of claim 1, comprising:
upon storing the log file on the chosen storage device, tagging the log file for later identification.

3. The method of claim 2, comprising:
searching the identified storage devices for the tagged log file; and
deleting the tagged log file upon collecting information from the tagged log file.

4. The method of claim 1, wherein choosing the storage device comprises choosing a storage device with the greatest remaining storage space available.

5. The method of claim 1, wherein storing the log file comprises:
determining whether a size of the log file is greater than the remaining storage space available on the chosen storage device; and
if the size of log file is greater than the remaining storage space available on the chosen storage device, choosing a scaled-down version of the log file to fit on the remaining storage space available on the chosen storage device.

6. The method of claim 1, wherein identifying the storage devices available for storing the log file comprises identifying additional hard disk drives (HDDs) installed in or coupled to a computing device, portable storage devices, on-board devices, and network-accessible locations.

7. A non-transitory computer-readable storage medium comprising program instructions which, when executed by a processor of a computing device, cause the processor to:
upon generating a log file, determine whether a primary log storage device is accessible;
if the primary log storage device is inaccessible, identify storage devices available for storing the log file;
determine factors for each storage device identified;
choose a storage device from the identified storage devices based on the determined factors; and
store the log file on the chosen storage device.

8. The non-transitory computer-readable storage medium of claim 7, wherein the factors for each storage device comprises a remaining storage space available for storing the log file and an ease of using the storage device.

9. The non-transitory computer-readable storage medium of claim 8, wherein the instructions to choose the storage device comprises instructions which, when executed by the processor, cause the processor to choose the storage device based on a weighted average of the factors determined for each storage identified.

10. The non-transitory computer-readable storage medium of claim 7, wherein the program instructions, when executed, further cause the processor to:
upon storing the log file on the chosen storage device, tag the log file for later identification.

11. The non-transitory computer-readable storage medium of claim 10, wherein the program instructions, when executed, further cause the processor to:
search the identified storage devices for the tagged log file; and
delete the tagged log file upon collecting information from the tagged log file.

12. The non-transitory computer-readable storage medium of claim 7, wherein the instructions to identify the storage devices comprises instructions which, when executed by the processor, cause the processor to identify additional hard disk drives (HDDs) installed in or coupled to the computing device, portable storage devices, on-board devices, and network-accessible locations.

13. A computing device comprising a processor to:
upon generating a log file, determine whether a primary log storage device is accessible;
if the primary log storage device is inaccessible, identify storage devices available for storing the log file;
for each storage device identified, determine remaining storage space available for storing the log file;
choose a storage device from the identified storage devices based on the remaining storage space available;
determine whether a size of the log file is greater than the remaining storage space available on the chosen storage device; and
if the size of log file is greater than the remaining storage space available on the chosen storage device, choose a scaled-down version of the log file to fit on the remaining storage space available on the chosen storage device.

14. The computing device of claim 13, wherein, upon storing the log file on the chosen storage device, the processor is to tag the log file for later identification.

15. The computing device of claim 14, wherein the processor is to:
search the identified storage devices for the tagged log file; and
delete the tagged log file upon collecting information from the tagged log file.
